(19) United States
(12) Patent Application Publication
(10) Pub. No.: US 2017/0076701 A1
(43) Pub. Date: Mar. 16, 2017

(54) DISPLAY METHOD OF DISPLAY PANEL, DISPLAY DEVICE AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Xinyu Hu, Beijing (CN); Wulin Li, Beijing (CN); Ming Hua, Beijing (CN)

(21) Appl. No.: 15/149,388

(22) Filed: May 9, 2016

(30) Foreign Application Priority Data
Sep. 11, 2015 (CN) 201510580501.6

(51) Int. Cl. G09G 5/391; G09G 5/00; G06T 3/40

(52) U.S. Cl. CPC G09G 5/391; G06T 3/40; G09G 5/003; G09G 2340/0407

(57) ABSTRACT

The present disclosure discloses a display method of a display panel, a display device and a display apparatus. A received high resolution (first resolution) image data is decomposed into multiple frames (n frames) of low resolution (second solution) image data, and for multiple frames (n frames) of low resolution image data corresponding to each frame of high resolution image data, various frames of image data in the multiple frames of second resolution image data are refreshed frame by frame at a predetermined frame refresh frequency. In this way, multiple frames of low resolution images which are presented in turn are observed by human eyes, and are combined into an original high resolution image by a brain, so as to achieve an effect of viewing an image with a high resolution. The present disclosure achieves the effect of viewing an image with a high resolution by increasing a refresh frequency of the low resolution image data. Compared with the manner of increasing a number of pixels in the related art, there is no need to change a mask process, which can reduce a cost of a high resolution display product.

### CROSS-REFERENCE TO RELATED APPLICATION(S)

This application claims priority to the Chinese Patent Application No. 201510580501.6, filed on Sep. 11, 2015, entitled “DISPLAY METHOD OF DISPLAY PANEL, DISPLAY DEVICE AND DISPLAY APPARATUS” which is incorporated herein by reference in its entirety.

### TECHNICAL FIELD

The present disclosure relates to the field of display technology, and more particularly, to a display method of a display panel, a display device and a display apparatus.

### BACKGROUND

With the continuous development of display technology, people have increasing requirements for definition of image display. Therefore, a high resolution has become a development trend of current display panels.

The resolution generally refers to a number of pixels of a display panel. For example, if a number of pixels of a display panel is 1920*1080, a resolution of the display panel is 1920*1080. As points, lines and planes on a display picture are comprised of pixels, the more the pixels of the display panel are, the finer the display picture is, and correspondingly, the more the information which can be displayed by the display panel is. Therefore, a viewing effect of the display picture is directly influenced by a value of the resolution of the display panel, which is one of important indexes for reflecting performance of the display panel.

Currently, a resolution of a display panel is improved by increasing a number of pixels of the display panel. Particularly, for a display panel with a fixed screen size, a resolution of the display panel can only be improved by increasing a number of pixels per unit area, i.e., reducing a pixel area. However, the smaller the pixel area in the display panel is, the more difficult the manufacturing process is, and therefore the higher the cost is.

### SUMMARY

Embodiments of the present disclosure provide a display method of a display panel, a display device and a display apparatus, to solve the problem in the related art that an effect of display at a high resolution needs to be achieved by increasing a number of pixels of the display panel which results in an increased cost of the display device.

The embodiments of the present disclosure provide a display method of a display panel comprising M×N pixel units arranged in a matrix, where M is a row number of the pixel units in the display panel, and N is a column number of the pixel units in the display panel, the method comprising:

receiving first resolution image data with a resolution of nM×N;

for each received frame of first resolution image data, decomposing the first resolution image data into n frames of second resolution image data with a resolution of M×N, wherein image data corresponding to an m^{th} frame of image data in the n frames of second resolution image data is data corresponding to an (nk+m)^{th} row of pixel units in the first resolution image data, where n is a positive integer greater than 1, m is a positive integer greater than 0 and less than or equal to n, and k=0, 1, 2, 3, . . . (M−1) for an m^{th} frame of second resolution image data; and

refreshing various frames of image data in the n frames of second resolution image data frame by frame at a predetermined frame refresh frequency according to the obtained n frames of second resolution image data, wherein the predetermined frame refresh frequency is equal to or greater than n times of a frame refresh frequency of the first resolution image data.

Preferably, for convenience of implementation, in the above display method according to the embodiments of the present disclosure, n is less than or equal to 4.

Preferably, for convenience of implementation, in the above display method according to the embodiments of the present disclosure, the frame refresh frequency of the first resolution image data is 60 Hz, that is, the predetermined frame refresh frequency is equal to 60*n Hz.

Preferably, for convenience of implementation, in the above display method according to the embodiments of the present disclosure, refreshing various frames of image data in the n frames of second resolution image data frame by frame at a predetermined frame refresh frequency according to the obtained every n frames of second resolution image data further comprises: refreshing various frames of image data in the n frames of second resolution image data frame by frame at the predetermined frame refresh frequency in an order of m from 1 to n according to the obtained n frames of second resolution image data.

Correspondingly, the embodiments of the present disclosure further provide a display device comprising a display panel and a display module, wherein the display panel comprises M×N pixel units arranged in a matrix, where M is a row number of the pixel units in the display panel, and N is a column number of the pixel units in the display panel, and the display module comprises:

an image reception unit configured to receive first resolution image data with a resolution of nM×N;

an image decomposition unit configured to, for each received frame of first resolution image data, decompose the first resolution image data into n frames of second resolution image data with a resolution of M×N, wherein data corresponding to the m^{th} frame of image data in the n frames of second resolution image data is data corresponding to the (nk+m)^{th} row of pixel units in the first resolution image data, where n is a positive integer greater than 1, m is a positive integer greater than 0 and less than or equal to n, and k=0, 1, 2, 3, . . . (M−1) for the m^{th} frame of second resolution image data; and

a display control unit configured to control the display panel to refresh various frames of image data in the n frames of second resolution image data frame by frame at a predetermined frame refresh frequency according to the obtained n frames of second resolution image data, wherein the predetermined frame refresh frequency is equal to or greater than n times of a frame refresh frequency of the first resolution image data.

Preferably, for convenience of implementation, in the above display device according to the embodiments of the present disclosure, n is less than or equal to 4.

Preferably, for convenience of implementation, in the above display device according to the embodiments of the present disclosure, the frame refresh frequency of the first resolution image data is 60 Hz, that is, the predetermined frame refresh frequency is equal to 60*n Hz.

Preferably, for convenience of implementation, in the above display device according to the embodiments of the present disclosure, the display control unit is further configured to:

control the display panel to refresh various frames of image data in the n frames of second resolution image data frame by frame at the predetermined frame refresh frequency in an order of m from 1 to n according to the obtained n frames of second resolution image data.

In a specific implementation, in the above display device according to the embodiments of the present disclosure, the display panel is a liquid display panel or an organic electroluminescent display panel.

Correspondingly, the embodiments of the present disclosure further provide a display apparatus comprising any of the display devices according to the embodiments of the present disclosure.

In the display method of a display panel, the display device and the display apparatus according to the embodiments of the present disclosure, a received high resolution image data is decomposed into multiple frames of low resolution image data, and for n frames of second resolution image data with a low resolution corresponding to each frame of first resolution image data with a high resolution, various frames of image data in the n frames of second resolution image data are refreshed frame by frame at a predetermined frame refresh frequency. In this way, multiple frames of low resolution images which are presented in turn and observed by human eyes are combined into an original high resolution image by a brain, so as to achieve an effect of viewing an image with a high resolution. This display method achieves the effect of viewing an image with a high resolution by decomposing the high resolution image data into multiple frames of low resolution image data and increasing a refresh frequency of each frame of low resolution image data. Compared with the manner of increasing a number of pixels in the related art, there is no need to change a mask process, which can reduce a cost of a high resolution display product.

### BRIEF DESCRIPTION OF THE DRAWINGS

FIG. 1 is a flowchart of a display method of a display panel according to an embodiment of the present disclosure; and

FIG. 2 is a structural diagram of a display device according to an embodiment of the present disclosure.

### DETAILED DESCRIPTION

Specific implementations of a display method of a display panel, a display device and a display apparatus according to embodiments of the present disclosure will be described in detail below in conjunction with accompanying drawings.

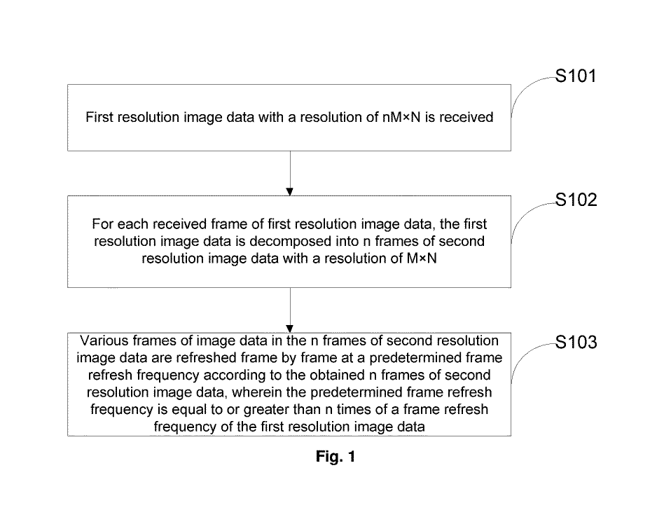

The embodiments of the present disclosure provide a display method of a display panel comprising M×N pixel units arranged in a matrix, where M is a row number of the pixel units in the display panel, and N is a column number of the pixel units in the display panel. As shown in FIG. 1, the display method may comprise the following steps.

In S101, first resolution image data with a resolution of nM×N is received.

In S102, for each received frame of first resolution image data, the first resolution image data is decomposed into n frames of second resolution image data with a resolution of M×N, wherein image data corresponding to the m^{th} frame of image data in the n frames of second resolution image data is data corresponding to an (nk+m)^{th} row of pixel units in the first resolution image data, where n is a positive integer greater than 1, m is a positive integer greater than 0 and less than or equal to n, and k=0, 1, 2, 3, . . . (M−1) for the m^{th} frame of second resolution image data.

In S103, various frames of image data in the n frames of second resolution image data are refreshed frame by frame at a predetermined frame refresh frequency according to the obtained n frames of second resolution image data, wherein the predetermined frame refresh frequency is equal to or greater than n times of a frame refresh frequency of the first resolution image data.

The above display method according to the embodiments of the present disclosure will be described by taking a specific example. Assuming that the display panel has 960 rows and 1080 columns of pixel units wherein n=4, the specific display method comprises:

(1) receiving first resolution image data with a resolution of 4×960×1080=3840×1080;

(2) for each received frame of first resolution image data, decomposing the first resolution image data into 4 frames of second resolution image data with a resolution of 960×1080, wherein in the 4 frames of second resolution image data,

data corresponding to a first frame of image data is data corresponding to the (4k+1)^{th} row of pixel units in the first resolution image data, wherein k=0, 1, 2, 3, . . . 959;

data corresponding to a second frame of image data is data corresponding to the (4k+2)^{th} row of pixel units in the first resolution image data, wherein k=0, 1, 2, 3, . . . 959;

data corresponding to a third frame of image data is data corresponding to the (4k+3)^{th} row of pixel units in the first resolution image data, wherein k=0, 1, 2, 3, . . . 959;

data corresponding to a fourth frame of image data is data corresponding to the (4k+4)^{th} row of pixel units in the first resolution image data, wherein k=0, 1, 2, 3, . . . 959;

(3) refreshing various frames of image data in the 4 frames of second resolution image data frame by frame at a predetermined frame refresh frequency according to the obtained 4 frames of second resolution image data, wherein the predetermined frame refresh frequency is equal to or greater than n times of a frame refresh frequency of the first resolution image data. In a case that the frame refresh frequency of the first resolution image is 60 Hz, the predetermined frame refresh frequency is 240 Hz.

In the above display method according to the embodiments of the present disclosure, a received high resolution image data is decomposed into multiple frames of low resolution image data, and for n frames of second resolution image data with a low resolution corresponding to each frame of first resolution image data with a high resolution, various frames of image data in the n frames of second resolution image data are refreshed frame by frame at a predetermined frame refresh frequency. In this way, multiple frames of low resolution images which are presented in turn and observed by human eyes are combined into an original high resolution image by a brain, so as to achieve an effect of viewing an image with a high resolution. This display method achieves the effect of viewing an image with a high resolution by decomposing the high resolution image data into multiple frames of low resolution image data and increasing a refresh frequency of each frame of low resolution image data. Therefore, compared with the manner of increasing a number of pixels in the related art, the above effect can be achieved without changing a mask process, which can reduce a cost of a high resolution display product.

It should be noted that in the above display method according to the embodiments of the present disclosure, it may be the case that all of the first resolution image data are firstly received, then each frame of first resolution image data is decomposed, and finally display is implemented according to all of the decomposed second resolution image data. Of course, it may also be the case that a frame of first resolution image data is decomposed into n frames of second resolution image data once the frame of first resolution image data is received, and finally display is implemented according to the n frames of decomposed second resolution image data. The specific implementation is not limited here.

In the above display method according to the embodiments of the present disclosure, the larger the value of n is, the better the effect of the resolution achieved by the display panel is, but the higher the required frame refresh frequency is. As current display panels can generally achieve a maximum frame refresh frequency of more than 240 Hz, in a specific implementation, n is selected to be less than or equal to 4. That is, n may be selected to be 2, 3 or 4. In a case that the maximum frame refresh frequency of the display panel can further be increased, the value of n may also be further increased, for example, n may be greater than 4.

It should be noted that in the above display method according to the embodiments of the present disclosure, the predetermined frame refresh frequency is set to be equal to or greater than 60 nHz for the purpose of enabling a total refresh frequency of the n frames of second resolution image data to be no less than 60 Hz. The reason is that a resolving capability of human eyes for a complete picture requires the display picture to be completely displayed within at least 1/60 seconds, that is, a refresh frequency of the complete image is 60 Hz, and as a result, in order to enable the human eyes not to feel phenomenon such as screen flicker when multiple frames of second resolution image data into which a frame of first resolution image data is decomposed are displayed, the multiple frames of second resolution image data are required to be completely displayed within 1/60 seconds, so that a brain can combine the multiple frames of second resolution images which are observed in turn by the human eyes into an original frame of first resolution image. Therefore, when a frame refresh frequency of each frame of second resolution image data is equal to 60 nHz, the time required to display a frame of second resolution image is 1/(60n) seconds, and the time required to completely display the n frames of second resolution image data is just equal to the minimum time of 1/60 seconds required by the human eyes.

Further, in the above display method according to the embodiments of the present disclosure, the predetermined frame refresh frequency is equal to 60 nHz, where n is equal to 2 or 4. The reason is that a common frame refresh frequency is 120 Hz or 240 Hz in the related art, and as a result, when the frame refresh frequency is selected as 120 Hz or 240 Hz in the above display method, the display method can be achieved by using the existing refresh technology, without designing a new refresh technology.

In a specific implementation, in the above display method according to the embodiments of the present disclosure, for the obtained n frames of second resolution image data, various frames of image data in the n frames of second resolution image data may be refreshed frame by frame in any order, which is not limited here.

Preferably, in the above display method according to the embodiments of the present disclosure, refreshing various frames of second resolution image data in the n frames of second resolution image data frame by frame at a predetermined frame refresh frequency according to the obtained n frames of second resolution image data further comprises: refreshing various frames of image data in the n frames of second resolution image data frame by frame at the predetermined frame refresh frequency in an order of m from 1 to n according to the obtained every n frames of second resolution image data.

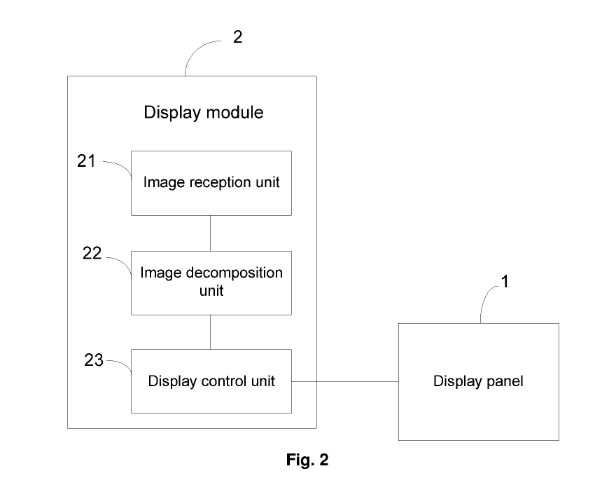

Based on the same inventive concept, the embodiments of the present disclosure further provide a display device. As shown in FIG. 2, the display device comprises a display panel 1 and a display module 2, wherein the display panel comprises M×N pixel units arranged in a matrix, where M is a row number of the pixel units in the display panel, and N is a column number of the pixel units in the display panel, and the display module 2 comprises:

an image reception unit 21 configured to receive first resolution image data with a resolution of nM×N;

an image decomposition unit 22 configured to, for each received frame of first resolution image data, decompose the first resolution image data into n frames of second resolution image data with a resolution of M×N, wherein data corresponding to the m^{th} frame of image data in the n frames of second resolution image data is data corresponding to the (nk+m)^{th} row of pixel units in the first resolution image data, where n is a positive integer greater than 1, m is a positive integer greater than 0 and less than or equal to n, and k=0, 1, 2, 3, . . . M−1 for the m^{th} frame of second resolution image data; and

a display control unit 23 configured to control the display panel 1 to refresh various frames of image data in the n frames of second resolution image data frame by frame at a predetermined frame refresh frequency according to the obtained n frames of second resolution image data, wherein the predetermined frame refresh frequency is equal to or greater than n times of a frame refresh frequency of the first resolution image data, i.e., 60×n Hz.

In the above display device comprising a display panel and a display module according to the embodiments of the present disclosure, a received high resolution image data is decomposed into multiple frames of low resolution image data, and for n frames of second resolution image data with a low resolution corresponding to each frame of first resolution image data with a high resolution, various frames of image data in the n frames of second resolution image data are refreshed frame by frame at a predetermined frame refresh frequency. In this way, multiple frames of low resolution images which are presented in turn and observed by human eyes are combined into an original high resolution image by a brain, so as to achieve an effect of viewing an image with a high resolution. This display device achieves the effect of viewing an image with a high resolution by decomposing the high resolution image data into multiple frames of low resolution image data and increasing a refresh frequency of each frame of low resolution image data. Therefore, compared with the manner of increasing a number of pixels in the related art, the above effect can be achieved without changing a mask process, which can reduce a cost of a high resolution display product.

Preferably, in the above display device according to the embodiments of the present disclosure, n is less than or equal to 4.

Preferably, in the above display device according to the embodiments of the present disclosure, the frame refresh frequency of the first resolution image data is 60 Hz, i.e., the predetermined frame refresh frequency is equal to 60×n Hz.

Preferably, in the above display device according to the embodiments of the present disclosure, the display control unit is further configured to:

control the display panel to refresh various frames of image data in the n frames of second resolution image data frame by frame at the predetermined frame refresh frequency in an order of m from 1 to n according to the obtained n frames of second resolution image data.

In the above display device according to the embodiments of the present disclosure, the display panel may be a liquid display panel or an organic electroluminescent display panel. Of course, the display panel may also be another type of display panel, which is not limited here.

Based on the same inventive concept, the embodiments of the present disclosure further provide a display apparatus comprising any of the display devices according to the embodiments of the present disclosure. The display apparatus may be any product or component having a display function such as a mobile phone, a tablet computer, a television, a display, a notebook computer, a digital photo frame, a navigator or the like. Implementations of the display apparatus may be known with reference to the embodiments of the above display device, and the repeated content will not be described.

In the display method of a display panel, the display device and the display apparatus according to the embodiments of the present disclosure, a received high resolution image data is decomposed into multiple frames of low resolution image data, and for n frames of second resolution image data with a low resolution corresponding to each frame of first resolution image data with a high resolution, various frames of image data in the n frames of second resolution image data are refreshed frame by frame at a predetermined frame refresh frequency. In this way, multiple frames of low resolution images which are presented in turn and observed by human eyes are combined into an original high resolution image by a brain, so as to achieve an effect of viewing an image with a high resolution. This display method achieves the effect of viewing an image with a high resolution by decomposing the high resolution image data into multiple frames of low resolution image data and increasing a refresh frequency of each frame of low resolution image data. Therefore, compared with the manner of increasing a number of pixels in the related art, the above effect can be achieved without changing a mask process, which can reduce a cost of a high resolution display product.

Obviously, those skilled in the art can make various modifications and variations to the present disclosure without departing from the spirit and scope of the present disclosure. Thus, if these modifications and variations of the present disclosure belong to the scope of the claims of the present disclosure and the equivalent technologies thereof, the present disclosure is also intended to include these modifications and variations.

I/we claim:

1. A display method of a display panel comprising M×N pixel units arranged in a matrix, where M is a row number of the pixel units in the display panel, and N is a column number of the pixel units in the display panel, the method comprising:
receiving first resolution image data with a resolution of nM×N;
for each received frame of first resolution image data, decomposing the first resolution image data into n frames of second resolution image data with a resolution of M×N, wherein image data corresponding to an m^{th} frame of image data in the n frames of second resolution image data is data corresponding to an the (nk+m)^{th} row of pixel units in the first resolution image data, where n is a positive integer greater than 1, m is a positive integer greater than 0 and less than or equal to n, and k=0, 1, 2, 3, . . . (M−1) for the m^{th} frame of second resolution image data; and
refreshing various frames of image data in the n frames of second resolution image data frame by frame at a predetermined frame refresh frequency according to the obtained n frames of second resolution image data, wherein the predetermined frame refresh frequency is equal to or greater than n times of a frame refresh frequency of the first resolution image data.

2. The display method according to claim 1, wherein n is less than or equal to 4.

3. The display method according to claim 1, wherein the frame refresh frequency of the first resolution image data is 60 Hz.

4. The display method according to claim 2, wherein the frame refresh frequency of the first resolution image data is 60 Hz.

5. The display method according to claim 1, wherein refreshing various frames of image data in the n frames of second resolution image data frame by frame at a predetermined frame refresh frequency further comprises:
refreshing various frames of image data in the n frames of second resolution image data frame by frame at the predetermined frame refresh frequency in an order of m from 1 to n according to the obtained n frames of second resolution image data.

6. The display method according to claim 2, wherein refreshing various frames of image data in the n frames of second resolution image data frame by frame at a predetermined frame refresh frequency further comprises:
refreshing various frames of image data in the n frames of second resolution image data frame by frame at the predetermined frame refresh frequency in an order of m from 1 to n according to the obtained n frames of second resolution image data.

7. The display method according to claim 3, wherein refreshing various frames of image data in the n frames of second resolution image data frame by frame at a predetermined frame refresh frequency further comprises:
refreshing various frames of image data in the n frames of second resolution image data frame by frame at the predetermined frame refresh frequency in an order of m from 1 to n according to the obtained n frames of second resolution image data.

8. The display method according to claim 4, wherein refreshing various frames of image data in the n frames of second resolution image data frame by frame at a predetermined frame refresh frequency further comprises:
refreshing various frames of image data in the n frames of second resolution image data frame by frame at the predetermined frame refresh frequency in an order of m from 1 to n according to the obtained n frames of second resolution image data.

9. A display device comprising a display panel and a display module, wherein the display panel comprises M×N pixel units arranged in a matrix, where M is a row number of the pixel units in the display panel, and N is a column number of the pixel units in the display panel, and the display module comprises:
an image reception unit configured to receive first resolution image data with a resolution of nM×N;
an image decomposition unit configured to, for each received frame of first resolution image data, decompose the first resolution image data into n frames of second resolution image data with a resolution of M×N, wherein data corresponding to the m^{th} frame of image data in the n frames of second resolution image data is data corresponding to the (nk+m)^{th} row of pixel units in the first resolution image data, where n is a positive integer greater than 1, m is a positive integer greater than 0 and less than or equal to n, and k=0, 1, 2, 3, . . . M−1 for the m^{th} frame of second resolution image data; and
a display control unit configured to control the display panel to refresh various frames of image data in the n frames of second resolution image data frame by frame at a predetermined frame refresh frequency according to the obtained n frames of second resolution image data, wherein the predetermined frame refresh frequency is equal to or greater than n times of a frame refresh frequency of the first resolution image data.

10. The display device according to claim 9, wherein n is less than or equal to 4.

11. The display device according to claim 9, wherein the frame refresh frequency of the first resolution image data is 60 Hz.

12. The display device according to claim 10, wherein the frame refresh frequency of the first resolution image data is 60 Hz.

13. The display device according to claim 9, wherein the display control unit is further configured to:
control the display panel to refresh various frames of image data in the n frames of second resolution image data frame by frame at the predetermined frame refresh frequency in an order of m from 1 to n according to the obtained n frames of second resolution image data.

14. The display device according to claim 10, wherein the display control unit is further configured to:
control the display panel to refresh various frames of image data in the n frames of second resolution image data frame by frame at the predetermined frame refresh frequency in an order of m from 1 to n according to the obtained n frames of second resolution image data.

15. The display device according to claim 11, wherein the display control unit is further configured to:
control the display panel to refresh various frames of image data in the n frames of second resolution image data frame by frame at the predetermined frame refresh frequency in an order of m from 1 to n according to the obtained n frames of second resolution image data.

16. The display device according to claim 12, wherein the display control unit is further configured to:
control the display panel to refresh various frames of image data in the n frames of second resolution image data frame by frame at the predetermined frame refresh frequency in an order of m from 1 to n according to the obtained n frames of second resolution image data.

17. The display device according to claim 9, wherein the display panel is a liquid display panel or an organic electroluminescent display panel.

18. The display device according to claim 10, wherein the display panel is a liquid display panel or an organic electroluminescent display device.

19. The display device according to claim 11, wherein the display panel is a liquid display panel or an organic electroluminescent display panel.

20. A display apparatus comprising a display device, the display device comprising a display panel and a display module, wherein the display panel comprises M×N pixel units arranged in a matrix, where M is a row number of the pixel units in the display panel, and N is a column number of the pixel units in the display panel, and the display module comprises:
an image reception unit configured to receive first resolution image data with a resolution of nM×N;
an image decomposition unit configured to, for each received frame of first resolution image data, decompose the first resolution image data into n frames of second resolution image data with a resolution of M×N, wherein data corresponding to the m^{th} frame of image data in the n frames of second resolution image data is data corresponding to the (nk+m)^{th} row of pixel units in the first resolution image data, where n is a positive integer greater than 1, m is a positive integer greater than 0 and less than or equal to n, and k=0, 1, 2, 3, . . . M−1 for the m^{th} frame of second resolution image data; and
a display control unit configured to control the display panel to refresh various frames of image data in the n frames of second resolution image data frame by frame at a predetermined frame refresh frequency according to the obtained n frames of second resolution image data, wherein the predetermined frame refresh frequency is equal to or greater than n times of a frame refresh frequency of the first resolution image data.
